(19) United States
(12) Patent Application Publication
(10) Pub. No.: US 2025/0071701 A1
(43) Pub. Date: Feb. 27, 2025

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN); Jianfei CAO, Dongguan (CN); Yun FENG, Dongguan (CN)

(73) Assignee: GUANGDONG OPPO MOBILE TELECOMMUNICATIONS CORP., LTD., Dongguan (CN)

(21) Appl. No.: 18/949,018

(22) Filed: Nov. 15, 2024

Related U.S. Application Data
(63) Continuation of application No. PCT/CN2022/098258, filed on Jun. 10, 2022.

(51) Int. Cl. H04W 56/00; H04W 74/0833

(52) U.S. Cl. CPC H04W 56/001; H04W 74/0833

(57) ABSTRACT

A communication method, a terminal device, and a network device are provided. The method includes: receiving, by a terminal device, first information, where the first information is used to indicate TAs of one or more TRPs. In this application, the first information is introduced to indicate the TAs of the one or more TRPs, that is, a TA is indicated by using a TRP as a granularity.

### CROSS-REFERENCE TO RELATED APPLICATIONS

This application is a continuation of International Application No. PCT/CN2022/098258, filed on Jun. 10, 2022, the disclosure of which is hereby incorporated by reference in its entirety.

### TECHNICAL FIELD

This application relates to the field of communications technologies, and more specifically, to a communication method, a terminal device, and a network device.

### RELATED ART

In a conventional manner, timing advance adjustment is performed on a timing advance (TA) by using a timing advance group (TAG) as a granularity, and one TAG corresponds to one serving cell.

### SUMMARY

This application provides a communication method, a terminal device, and a network device, which mainly relate to the following aspects.

According to a first aspect, a terminal device is provided, including a transceiver, a memory, and a processor. The memory is configured to store a program, and the processor is configured to invoke the program in the memory and control the transceiver to send and/or receive a signal, to cause the terminal device to execute the method comprising: receiving first information, wherein the first information is used to indicate timing advances TAs of one or more transmitting and receiving points TRPs.

According to a second aspect, a network device is provided, including a memory and a processor. The memory is configured to store a program, and the processor is configured to invoke the program in the memory and control the transceiver to send and/or receive a signal, to cause the network device to execute the method comprising: sending first information, wherein the first information is used to indicate timing advances TAs of one or more transmitting and receiving points TRPs.

According to a third aspect, a communication method is provided, including: receiving, by a terminal device, first information, where the first information is used to indicate TAs of one or more TRPs.

### BRIEF DESCRIPTION OF DRAWINGS

FIG. 1A to FIG. 1C are system architectural diagrams of communications systems to which embodiments of this application are applicable.

FIG. 2 shows a format of a MAC CE that carries a TAC.

FIG. 3 shows a format of a MAC CE that carries a TAC.

FIG. 4 shows a format of a MAC RAR that carries a TAC.

FIG. 5 is a schematic diagram of a multi-TRP scenario to which an embodiment of this application is applicable.

FIG. 6 is a flowchart of a communication method according to an embodiment of this application.

FIG. 7 is a schematic diagram of a format of a MAC CE according to an embodiment of this application.

FIG. 8 is a schematic diagram of a format of a MAC CE according to another embodiment of this application.

FIG. 9 is a schematic diagram of a format of a MAC CE according to another embodiment of this application.

FIG. 10 is a schematic diagram of a format of a MAC CE according to another embodiment of this application.

FIG. 11 is a schematic diagram of a format of a MAC CE according to another embodiment of this application.

FIG. 12 is a schematic diagram of a format of a MAC RAR that carries a TAC according to an embodiment of this application.

FIG. 13 is a schematic diagram of a format of a MAC CE that carries a TAC according to an embodiment of this application.

FIG. 14 is a schematic diagram of an association relationship between a TA and a timer according to an embodiment of this application.

FIG. 15 is a schematic diagram of a terminal device according to an embodiment of this application.

FIG. 16 is a schematic diagram of a network device according to an embodiment of this application.

FIG. 17 is a schematic structural diagram of an apparatus according to an embodiment of this application.

### DESCRIPTION OF EMBODIMENTS

### Communications System Architecture

The technical solutions in embodiments of this application may be applied to various communications systems, for example, a global system for mobile communications (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, an NTN system, a universal mobile telecommunications system (UMTS), a wireless local area network (WLAN), wireless fidelity (WiFi), a fifth-generation (5G) system, or another communications system, for example, a future communications system such as a sixth-generation mobile communications system or a satellite communications system.

Generally, a number of connections supported by a conventional communications system is limited, and is also easy to implement. However, with development of communications technologies, a mobile communications system not only supports conventional communication, but also supports, for example, device-to-device (D2D) communication, machine-to-machine (M2M) communication, machine type communication (MTC), vehicle-to-vehicle (V2V) communication, or vehicle to everything (V2X) communication. Embodiments of this application may also be applied to these communications systems.

The communications system in embodiments of this application may be applied to a carrier aggregation (CA) scenario, a dual connectivity (DC) scenario, or a standalone (SA) networking scenario.

The communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a dedicated spectrum.

Embodiments of this application may be applied to an NTN system, or may be applied to a terrestrial network (TN) system. By way of example rather than limitation, the NTN system includes an NR-based NTN system and an IoT-based NTN system.

Embodiments of this application are described with reference to a network device and a terminal device. The terminal device may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, a user apparatus or the like.

In embodiments of this application, the terminal device may be a station (ST) in a WLAN, or may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (PLMN).

In embodiments of this application, the terminal device may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the terminal device may function as a base station. For example, the terminal device may function as a scheduling entity that provides a sidelink signal between terminal devices in V2X, D2D, or the like. For example, a cellular phone and a vehicle communicate with each other by using a sidelink signal. A cellular phone and a smart household device communicate with each other without relaying a communication signal by a base station.

In embodiments of this application, the terminal device may be deployed on land, including being indoors or outdoors, may be handheld, wearable, or vehicle-mounted; may be deployed on water (for example, on a ship); or may be deployed in the air (for example, on an airplane, a balloon, or a satellite).

In embodiments of this application, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like. The terminal device in embodiments of this application may also be referred to as a terminal, user equipment (UE), an access terminal device, a vehicle-mounted terminal, an industrial control terminal, a UE unit, a UE station, a mobile site, a mobile station, a remote station, a remote terminal device, a mobile device, a UE terminal device, a wireless communications device, a UE agent, a UE apparatus, or the like. The terminal device may be stationary or mobile.

By way of example rather than limitation, in embodiments of this application, the terminal device may alternatively be a wearable device. The wearable device may also be referred to as a wearable smart device, and is a general term for wearable devices such as glasses, gloves, watches, clothes, and shoes that are intelligently designed and developed by applying wearable technologies to daily wearing. The wearable device is a portable device that is directly worn on a body or integrated into clothes or an accessory of a user. In addition to being a hardware device, the wearable device can also implement powerful functions through software support, data exchange, and cloud interaction. In a broad sense, the wearable smart device includes a full-featured and large-sized device that can implement all or some functions without relying on a smartphone, for example, a smart watch or smart glasses, and a device that only focuses on a specific type of application function and needs to be used in cooperation with another device such as a smartphone, for example, various smart bracelets and smart jewelries for physical sign monitoring.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover the following various names, or may be replaced with the following names, such as a NodeB, an evolved NodeB (eNB), a next generation NodeB (gNB), a relay station, a transmitting and receiving point (TRP), a transmitting point (TP), a master eNodeB (MeNB), a secondary eNodeB (SeNB), a multi-standard radio (MSR) node, a home eNodeB, a network controller, an access node, a radio node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. The base station may be alternatively a communications module, a modem, or a chip disposed in the foregoing device or apparatus. Alternatively, the base station may be a mobile switching center, a device that functions as a base station in device-to-device D2D, vehicle-to-everything (V2X), and machine-to-machine (M2M) communication, a network side device in a 6G network, a device that functions as a base station in a future communications system, or the like. The base station may support networks with a same access technology or different access technologies. A specific technology and a specific device form used by the network device are not limited in embodiments of this application.

The base station may be stationary or mobile. For example, a helicopter or an unmanned aerial vehicle may be configured to function as a mobile base station, and one or more cells may move depending on a location of the mobile base station. In another example, a helicopter or an unmanned aerial vehicle may be configured to function as a device that communicates with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted; may be deployed on a water surface; or may be deployed on a plane, a balloon, or a satellite in the air. In embodiments of this application, a scenario in which the network device and the terminal device are located is not limited.

By way of example rather than limitation, in embodiments of this application, the network device may have a mobile feature, for example, the network device may be a movable device. In some embodiments of this application, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of this application, the network device may alternatively be a base station located on land, water, or the like.

In embodiments of this application, the network device may provide a service for a cell, and the terminal device communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell. The small cell herein may include a metro cell, a micro cell, a pico cell, a femto cell, or the like. These small cells feature small coverage and low transmit power, and are suitable for providing a high-speed data transmission service.

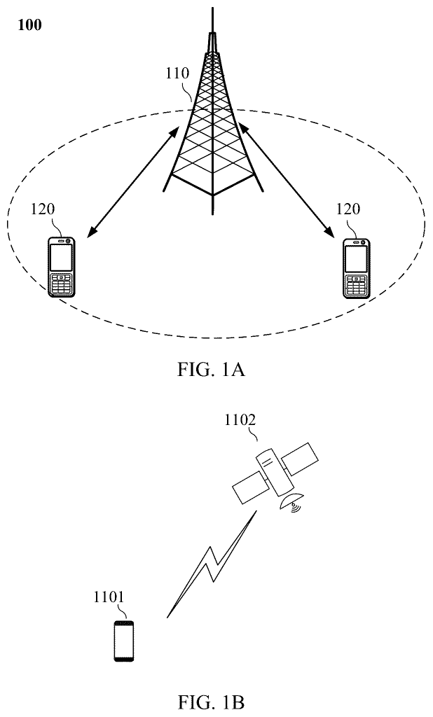

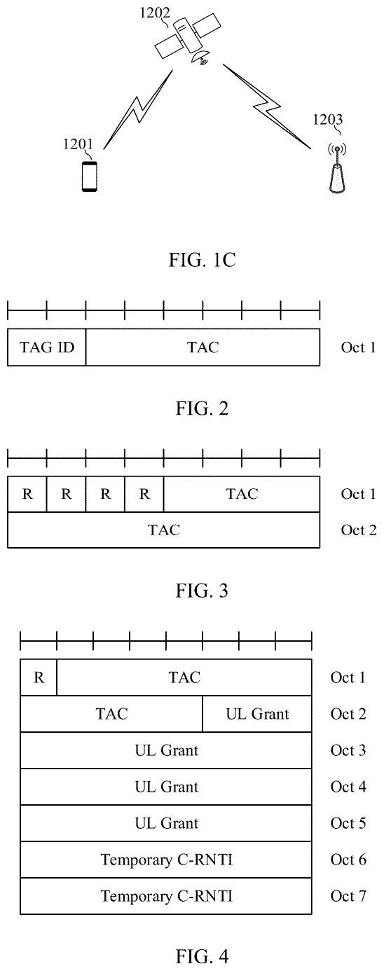

Exemplarily, FIG. 1A is a schematic diagram of an architecture of a communications system according to an embodiment of this application. As shown in FIG. 1A, a communications system 100 may include a network device 110, and the network device 110 may be a device that communicates with a terminal device 120 (or referred to as a communications terminal or a terminal). The network device 110 may provide communication coverage for a specific geographical area, and may communicate with the terminal device within the coverage area.

FIG. 1A exemplarily shows one network device and two terminal devices. In some embodiments of this application, the communications system 100 may include a plurality of network devices, and another number of terminal devices may be included within a coverage range of each network device. This is not limited in embodiments of this application.

Exemplarily, FIG. 1B is a schematic diagram of an architecture of another communications system according to an embodiment of this application. Referring to FIG. 1, a terminal device 1101 and a satellite 1102 are included, and wireless communication may be performed between the terminal device 1101 and the satellite 1102. A network formed between the terminal device 1101 and the satellite 1102 may also be referred to as an NTN. In the architecture of the communications system shown in FIG. 1B, the satellite 1102 may have a function of a base station, and direct communication may be performed between the terminal device 1101 and the satellite 1102. In this system architecture, the satellite 1102 may be referred to as a network device. In some embodiments of this application, the communications system may include a plurality of network devices 1102, and another number of terminal devices may be included within a coverage range of each network device 1102. This is not limited in embodiments of this application.

Exemplarily, FIG. 1C is a schematic diagram of an architecture of another communications system according to an embodiment of this application. Referring to FIG. 1C, a terminal device 1201, a satellite 1202, and a base station 1203 are included, wireless communication may be performed between the terminal device 1201 and the satellite 1202, and communication may be performed between the satellite 1202 and the base station 1203. A network formed among the terminal device 1201, the satellite 1202, and the base station 1203 may also be referred to as an NTN. In the architecture of the communications system shown in FIG. 1C, the satellite 1202 may not have a function of a base station, and communication between the terminal device 1201 and the base station 1203 needs to be relayed by using the satellite 1202. In this system architecture, the base station 1203 may be referred to as a network device. In some embodiments of this application, the communications system may include a plurality of network devices 1203, and another number of terminal devices may be included within a coverage range of each network device 1203. This is not limited in embodiments of this application.

It should be noted that FIG. 1A to FIG. 1C are merely examples of systems to which this application is applicable. Certainly, the methods shown in embodiments of this application may also be applied to other systems, such as a 5G communications system and an LTE communications system. This is not specifically limited in embodiments of this application.

In some embodiments of this application, the wireless communications systems shown in FIG. 1A to FIG. 1C may further include another network entity such as a mobility management entity (MME) or an access and mobility management function (AMF). This is not limited in embodiments of this application.

It should be understood that a device having a communication function in a network/system in embodiments of this application may be referred to as a communications device. The communications system 100 shown in FIG. 1A is used as an example. The communications device may include the network device 110 and the terminal device 120 that have a communication function. The network device 110 and the terminal device 120 may be the foregoing specific devices, and details are not described herein again. The communications device may further include another device in the communications system 100, for example, another network entity such as a network controller or a mobility management entity. This is not limited in embodiments of this application.

It should be understood that, an “indication” mentioned in embodiments of this application may be a direct indication or an indirect indication, or may indicate an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In descriptions of embodiments of this application, the term “corresponding” may mean that there is a direct or indirect correspondence between the two, or may mean that there is an association relationship between the two, or may mean that there is a relationship such as indicating and being indicated, or configuring and being configured.

“Configured” in embodiments of this application may include being configured by using at least one of a system message, radio resource control (RRC) signaling, or a media access control control element (MAC CE).

In some embodiments of this application, “predefined” or “preset” may be implemented by prestoring corresponding code or a corresponding table in a device (for example, including the terminal device and the network device) or in other manners that can be used to indicate related information, and a specific implementation thereof is not limited in this application. For example, being predefined may refer to being defined in a protocol.

In some embodiments of this application, the “protocol or standard” may refer to a standard protocol in the communications field, and may include, for example, an LTE protocol, an NR protocol, and a related protocol applied to a future communications system, which is not limited in this application.

For ease of understanding, some related technical knowledge related to embodiments of this application is first introduced. The following related technologies, as optional solutions, may be randomly combined with the technical solutions of embodiments of this application, all of which fall within the protection scope of embodiments of this application. Embodiments of this application include at least part of the following content.

### Timing Advance (TA)

The TA is generally used for uplink transmission, and may mean that a system frame in which a terminal device sends uplink data should be a specific time ahead of a respective downlink frame. For example, a timing advance for the terminal device is performing transmission in advance on a basis of using the first symbol of a slot in which the terminal device receives a downlink channel or a channel as a downlink reference.

A carrier aggregation scenario is used as an example. The terminal device may support different carriers (also referred to as “serving cells”). Different carriers may have different TAs. Therefore, a concept of a timing advance group (TAG) is introduced. Generally, one TAG may include TAs of one or more serving cells. A TAG including a special cell (Spcell) may be referred to as a primary timing advance group (primary timing advance group, PTAG), and correspondingly, a TAG other than the PTAG may be referred to as a secondary timing advance group (STAG). The Spcell may include a primary cell (PCell) or a primary secondary cell (PSCell).

According to current communications standards (including NR, 3GPP Rel.17, and the like), in a cell group (CG), the terminal device may be configured with a maximum of four timing advance groups (TAG). An RRC configuration for configuring a TAG (denoted by “TAG-Config”) may be expressed as follows:

```
    -- ASN1START
    -- TAG-TAG-CONFIG-START
```

| | |
|---|---|
| TAG-Config ::= | SEQUENCE { |
| tag-ToReleaseList | SEQUENCE (SIZE (1..maxNrofTAGs)) OF |

TAG-Id OPTIONAL, -Need N

| | |
|---|---|
| tag-ToAddModList | SEQUENCE (SIZE (1..maxNrofTAGs)) OF |

```
  TAG OPTIONAL-- Need N
    }
```

| | |
|---|---|
| TAG ::= | SEQUENCE { |
| tag-Id | TAG-Id, |
| timeAlignmentTimer | TimeAlignmentTimer, |

```
      ...
    }
```

| | |
|---|---|
| TAG-Id ::= | INTEGER (0..maxNrofTAGs-1) |
| TimeAlignmentTimer ::= | ENUMERATED {ms500, ms750, |

```
ms1280, ms1920, ms2560, ms5120, ms10240, infinity}
    -- TAG-TAG-CONFIG-STOP
    -- ASN1STOP
```

Generally, the RRC configuration may include a TAG configuration (denoted by “TAG-Config”), TAG information (denoted by “TAG”), a TAG identity (denoted by “TAG-Id”), and a TA timer (denoted by “timeAlignmentTimer”). The TAG configuration may include a release list (denoted by “tag-ToReleaseList”) and a TAG add list (denoted by “tag-ToAddModList”). The TAG information may include a TAG identity (denoted by “tag-Id”) and a TA timer (denoted by “timeAlignmentTimer”). Duration corresponding to the TA timer may be listed in an enumeration manner, including {500 ms, 750 ms, 1280 ms, 1920 ms, 2560 ms, 5120 ms, 10240 ms, infinity}.

Generally, validity of a TA may be maintained by using a TA timer. In other words, when a terminal device receives information indicating a TA and sent by a network device (for example, a TA command (TAC) below), the terminal device may start or restart a TA timer. When the TA timer does not expire, the TA maintained by the TA timer is valid, and the terminal device may communicate with the network device based on the TA. On the contrary, when the TA timer expires, the TA maintained by the TA timer fails (or is invalid), and the terminal device can no longer communicate with the network device based on the TA in this case.

It should be noted that one CG may include a plurality of serving cells, and one TAG identity is allocated to each serving cell.

As described above, the TAG information may include a TAG identity and a TA timer. In other words, the TA timer included in the TAG configuration is used to maintain validity of a TA in a TAG indicated by the TAG identity. In this case, for ease of description, it may be said hereinafter that the TA timer is associated with the TAG.

The following describes how to calculate a TA.

In some implementations, a TA may be calculated by using a formula (N_{TA}+N_{TA,offset})×T_{c}, where N_{TA,offset} denotes a timing advance offset (TA offset), N_{TA} denotes a TA adjustment amount, and T_{c} denotes a minimum time unit in a communications system (for example, an NR system). Typically, T_{c}=1/(4096×480 kHz).

Generally, in one CG, each serving cell may be preconfigured with one N_{TA,offset}. In addition, for N_{TA}, differential adjustment may be provided by a MAC CE of the network device, that is, a current TA (also referred to as a “new TA” and denoted by N_{TA}_{_{new}}) is adjusted forward or backward in terms of time based on a previous TA (also referred to as an “old TA” and denoted by N_{TA}_{_{old}}). A calculation formula for the adjustment is as follows:

$${N}_{( {TA}_{new} )} = {N}_{( {TA}_{old} )} + ( {T}_{A} - 31 ) * 16 * 64 * / {2}^{μ}$$

Alternatively, N_{TA}_{_{old}} is a TA adjustment amount used before a TA command (TAC) is received, and N_{TA}_{_{new}} is a TA adjustment amount updated after the TAC is received. T_{A} is determined based on the TAC. In addition, a granularity for the TA adjustment may be a TAG.

FIG. 2 shows a format of a MAC CE that carries a TAC. Referring to FIG. 2, the MAC CE may include a TAG identity (TAG ID) field and a TAC field. Generally, a length of the TAG ID field may be two bits, and a TAG identity of a TAG that includes a SpCell is 0. The TAC field is used to indicate a TA index value TA (0, 1, 2, . . . 63) for controlling a timing adjustment amount that a MAC entity has to apply (as specified in TS 38.213[6]). A length of the field may be six bits.

In some other implementations, the TA adjustment manner may be based on a TA absolute value (also referred to as an “absolute TA”). That is, a previous TA adjustment value does not need to be considered, and the network device may directly give an absolute TA “N′_{TA}” by using a payload (payload) of an absolute MAC CE (Absolute MAC CE) or an RAR MAC. Generally, a value of the absolute TA may range from 0 to 3846. Correspondingly, the TA may be calculated by using a formula N′_{TA} T_{A}×16×64×2^{μ}, where T_{A} is determined based on the TAC.

In some scenarios, the absolute TA and T_{A} described above are obtained in a random access procedure, and the obtained TA is applicable to a TAG corresponding to a target cell for random access. Therefore, signaling that carries a TAC may not include a TAG-ID. For example, the absolute MAC CE may be used in a 2-step random access procedure, and 2-step random access may only be initiated to a SpCell. Therefore, the absolute MAC CE is applicable to a PTAG corresponding to the MAC entity, that is, the PTAG includes a SpCell.

FIG. 3 shows a format of a MAC CE that carries a TAC. Referring to FIG. 3, a length of the MAC CE may be two bytes, namely, 16 bits. The MAC CE may include a TAC field, and the TAC field may occupy 12 bits. This field is used to indicate a TA index value of a time adjustment amount that a MAC entity applies. In addition, the remaining four bits in the MAC CE may be used as reserved bits (denoted by “R”) and may be set to 0.

FIG. 4 shows a format of a MAC random access response (RAR) that carries a TAC. Referring to FIG. 4, a length of the MAC RAR may be seven bytes, namely, 56 bits. A first byte (denoted by “Oct 1”) may include a TAC field, and the TAC field may occupy seven bits. This field is used to indicate a TA index value of a time adjustment amount that a MAC entity applies. The remaining one bit in the Oct 1 may be used as a reserved bit (denoted by “R”) and may be set to 0.

A second byte (denoted by “Oct 2”) may also include a TAC field, and the TAC field may occupy five bits. The remaining three bits in the Oct 2 may carry an uplink grant (UL Grant).

In a third byte to a fifth byte (denoted by “Oct 3 to Oct 5”), an uplink grant (UL Grant) may also be carried. In a sixth byte and a seventh byte (denoted by “Oct 6 and Oct 7”), a temporary cell radio network temporary identifier (C-RNTI) may be carried.

Scheduling in a Multi-TRP (mTRP) Scenario

Referring to FIG. 5, in a multiple DCT-multiple TRP (mDCI-mTRP) scenario, each TRP may schedule transmission of its PDSCH by using respective DCI. That is, a TRP 1 may schedule transmission of a physical downlink shared channel (physical downlink shared channel, PDSCH) 1 by using downlink control information (DCI) carried in a physical downlink control channel (PDCCH) 1, and a TRP 2 may schedule transmission of a PDSCH 2 by using DCI carried in a PDCCH 2.

The applicant believes that in evolution of subsequent protocols, each TRP may schedule transmission of its PUSCH. Still referring to FIG. 5, that is, the TRP 1 may schedule transmission of a PUSCH 1 by using the DCI carried in the PDCCH 1, and the TRP 2 may schedule transmission of a PUSCH 2 by using the DCI carried in the PDCCH 2.

It should be noted that in the mDCI-mTRP scenario, a demand for DCI is large, and each TRP performs scheduling independently, thus increasing a number of control resource sets (CORESET) occupied by DCI. In some implementations, CORESETs may be grouped based on corresponding RRC parameters “control resource set pool index (CORESETPoolIndex)”, that is, control resource sets whose CORESETPoolIndex is “0” may be classified into one group corresponding to the TRP 1, and control resource sets whose CORESETPoolIndex is “1” may be classified into one group corresponding to the TRP 2. In addition, when a network device does not configure CORESETPoolIndex for a control resource set, CORESETPoolIndex may be “0” by default.

In addition, if a terminal device operates in a single TRP (sTRP) mode, a reference point of a timing advance for the terminal device is a time point for downlink reception. In an mTRP scenario, the terminal device may still use one of the two TRPs as a reference point for downlink reception to adjust a TA. For example, a TRP whose CORESETPoolIndex is 0 is used as the reference point for downlink reception, or a specific TRP that may be configured by the network device is used as the reference point for downlink reception. In this case, a premise based on a single downlink reference point may be that the terminal device has only one set of downlink receive timelines, that is, depending on a capability of the terminal device.

Certainly, for a terminal device with a relatively strong capability, two different reference points for downlink reception may also be used. Still referring to FIG. 5, the two TRPs may correspond to different downlink reference points. In this case, two TA values indicated by the network device are adjusted based on respective reference points.

### Uplink Multi-TRP Operation

In an existing communications protocol (for example, 3GPP Rel.17), multi-TRP based uplink PUCCH/PUSCH retransmission (repetition) is supported, with the aim of enhancing uplink coverage and transmission reliability. A terminal device needs to send, to different TRPs, physical uplink control channels (PUCCH)/physical uplink shared channels (PUSCH) that carry same content. For PUSCH retransmission, only sDCI-based PUSCH retransmission is supported in an existing standard, in which one timing advance TA is used to sequentially send PUSCHs to different TRPs. For mDCI-based PUSCH retransmission, because there may not be enough ideal backhauls (backhaul) between a plurality of TRPs as connections, independent scheduling by the plurality of TRPs on the terminal device may cause overlapping of different PUSCHs/PUCCHs in terms of time.

For sDCI-based mPUSCH transmission, a sounding reference signal resource set indicator (sounding reference signal resource set indicator) field may be used in DCI for uplink scheduling, and one or two SRS resource sets are indicated by using the SRS resource set indicator field. The SRS resource sets point to transmission of one or two TRPs, and sTRP or mTRP uplink transmission may be dynamically adjusted.

Currently, a first TRP and a second TRP may be separately represented by using a first SRS resource set (1^{st} SRS resource set) and a second SRS resource set (2^{nd} SRS resource set). Therefore, in embodiments of this application, a TRP identity may also be determined based on an identity of an SRS resource set. For example, a TRP identity may be an identity of an SRS resource set.

In addition, for timing advances of an uplink channel and an uplink signal, a same TA value may be used for a PUSCH/PUCCH/SRS (transmitted toward one TRP or directed at two TRPs).

As described above, in a conventional manner, timing advance adjustment is performed on a TA by using a TAG as a granularity, and one TAG corresponds to one serving cell. This manner of configuring a TA by using a serving cell as a granularity may be too coarse, and consequently interference may still exist when a terminal device communicates with a TRP based on a TA corresponding to a serving cell to which the TRP belongs.

For example, if one serving cell includes a plurality of TRPs, there may be different distances between different TRPs and the terminal device. In this case, if the terminal device still sends uplink signals to the plurality of TRPs within the serving cell based on a TA corresponding to the serving cell, interference may still exist when the uplink signals arrive at the TRPs. In other words, this manner of configuring a TA by using a serving cell as a granularity may be too coarse, and consequently interference may still exist when a terminal device communicates with a transmitting and receiving point based on a TA corresponding to a serving cell to which the TRP belongs.

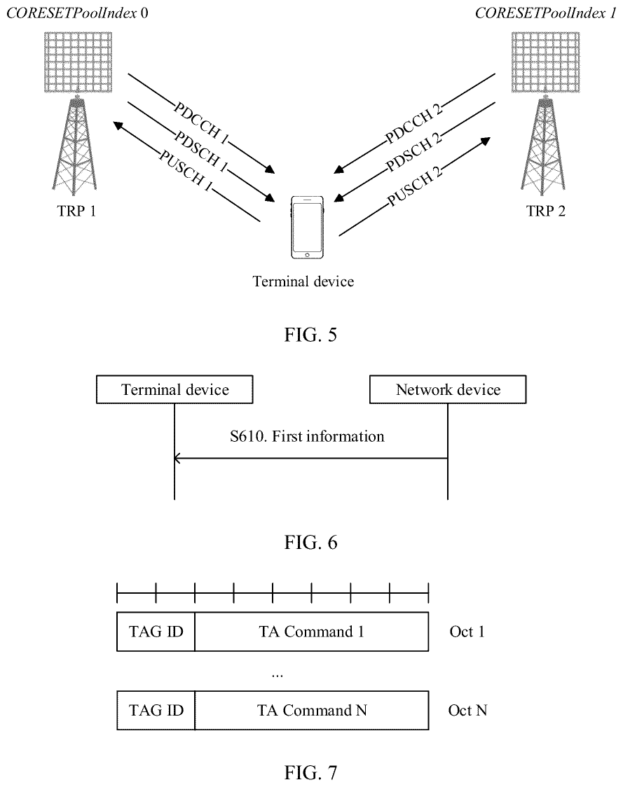

Therefore, to avoid the foregoing problem, an embodiment of this application provides a wireless communication method. A TA is indicated by using a TRP as a granularity, thereby reducing interference caused when a terminal device communicates with a TRP. The communication method in embodiments of this application is described below with reference to FIG. 6. The method shown in FIG. 6 includes step S610.

Step S610: A network device sends first information to a terminal device.

The first information is used to indicate TAs of one or more TRPs. The TAs corresponding to the one or more TRPs may be the TA adjustment amounts described above. Certainly, the TAs corresponding to the one or more TRPs may be alternatively specific TA values. This is not limited in embodiments of this application. In addition, if the TA is a TA adjustment value, for a manner of determining a TA based on a TA adjustment value, refer to the foregoing descriptions. For brevity, details are not described herein again.

In some implementations, the first information may be carried in a MAC protocol data unit (PDU) (for example, a MAC CE or a MAC RAR), or DCI. Certainly, in embodiments of this application, the first information may be alternatively carried in other signaling or another message. This is not limited in embodiments of this application.

With reference to Embodiment 1 and Embodiment 2, the following describes a manner of indicating TAs of one or more TRPs in embodiments of this application.

### Embodiment 1

In this embodiment of this application, the TAs of the one or more TRPs may be indicated in a TAG-based TA indication manner. That is, the first information includes a TA of a first TAG, and the first TAG is associated with the one or more TRPs.

In this embodiment of this application, the TAs of the one or more TRPs may be indicated in a conventional TAG-based TA indication manner. In this case, a TAG is no longer associated with a serving cell, but is associated with a TRP. This conventional TA indication manner can improve compatibility with an existing protocol.

In some scenarios, some serving cells of the terminal device may not be configured with mTRP, and other serving cells may be configured with mTRP. In this case, the first TAG may be associated with the one or more TRPs, and the first TAG may further be associated with one or more serving cells. A serving cell associated with the first TAG may be a serving cell configured with no mTRP. Certainly, in some other scenarios, the first TAG may be associated with only the one or more TRPs. This is not limited in this embodiment of this application.

As described above, in the TAG-based TA indication manner, a TAG may be associated with a TRP. Therefore, the terminal device further needs to learn an association relationship between a TAG and a TRP. In a possible implementation, the association relationship between the TAG and the TRP may be determined by using configuration information of the network device. For example, an association relationship between the first TAG and the one or more TRPs is determined based on the configuration information of the network device. The configuration information of the network device may be, for example, an RRC configuration.

It should be noted that, that the association relationship is determined based on the configuration information may include: the configuration information may directly configure the association relationship. Certainly, that the association relationship is determined based on the configuration information may alternatively include: the configuration information may indirectly configure the association relationship. For example, the configuration information may configure only a number of TAGs, and an association relationship between different TAGs and TRPs may be determined in another manner (for example, a default manner). The default manner may be, for example, pre-stipulated in a protocol, or may be built into the terminal device when the terminal device is at delivery. This is not limited in this embodiment of this application.

In some implementations, the configuration information of the network device may be configuration information of a serving cell of the terminal device, where configuration information of each serving cell of the terminal device may include identities of a plurality of TAGs (denoted by “tag-ID”), and the identities of the plurality of TAGs may be separately associated with a plurality of TRPs. Certainly, in some other implementations, the configuration information of the network device may be separate configuration information, and is not included in the configuration information of the serving cell. This is not limited in this embodiment of this application.

It should be noted that, that the identities of the plurality of TAGs may be separately associated with a plurality of TRPs may include: identities of different TAGs in the identities of the plurality of TAGs are associated with different TRPs in the plurality of TRPs, or the identities of the plurality of TAGs are in a one-to-one correspondence with the plurality of TRPs. Certainly, an association relationship between the identities of the plurality of TAGs and the plurality of TRPs may be a one-to-many association relationship or a many-to-one association relationship. This is not limited in this embodiment of this application.

The following describes a solution of determining an association relationship between a TAG and a TRP based on configuration information in this embodiment of this application by using an implementation 1 to an implementation 3 as examples.

In implementation 1, each serving cell configuration may include a number of tag-IDs, and an association relationship between a tag-ID and a TRP may be a default association relationship. Assuming that the number of tag-IDs in the serving cell configuration is 2, the default association relationship between the tag-ID and the TRP includes: a tag-ID is associated with a TRP corresponding to coresetPoolIndex=0 and a tag-ID-r18 is associated with a TRP corresponding to coresetPoolIndex=1.

Pseudo code corresponding to the serving cell configuration may be shown below.

| “TAG-Id” denotes an identity of a corresponding tag-ID. | |
|---|---|
| tag-ID | TAG-Id, |
| tag-ID-r18 | TAG-Id, OPTIONAL, Need S |

It should be noted that a TA associated with a TRP in a serving cell may be indicated by configuring whether “tag-ID-r18” is default. That is, in a case that a serving cell corresponding to the serving cell configuration includes a plurality of TRPs (for example, two TRPs), if “tag-ID-r18” is default, it may indicate that the plurality of TRPs in the serving cell share a same TAG-ID, and the plurality of TRPs in the serving cell correspond to a same TA in this case. On the contrary, if “tag-ID-r18” is not default, it may indicate that TAs corresponding to the plurality of TRPs in the serving cell are determined based on respective associated TAG-IDs, and the plurality of TRPs in the serving cell may correspond to different TAs in this case.

In addition, a TA associated with a TRP in a serving cell may alternatively be indicated by indicating whether “tag-ID-r18” is valid. That is, in a case that a serving cell corresponding to the serving cell configuration includes a plurality of TRPs (for example, two TRPs), and a TAG identity “tag-ID-r18” may not be default, “tag-ID-r18” is valid only when a multiple TRP-multiple TA function (denoted by “mTRP-mTA”) is configured, it may indicate that TAs corresponding to TRPs in the serving cell are determined based on respective associated TAG-IDs, and the plurality of TRPs in the serving cell may correspond to different TAs in this case. On the contrary, if the mTRP-mTA function is not configured, and “tag-ID-r18” is invalid, it may indicate that the plurality of TRPs in the serving cell share a same TAG-ID, and the plurality of TRPs in the serving cell correspond to a same TA in this case.

In implementation 2, a tag-ID list may be configured for each serving cell, and the tag-ID list includes an association relationship between a tag-ID and a TRP in a serving cell.

Pseudo code corresponding to the tag-ID list (denoted by “tag-IDList”) may be shown below. The tag-ID list includes a TRP-TA configuration (denoted by “TRP-TA-config”) and a maximum number of TRP-TA configurations (denoted by “maxNrofTRP-TA-config”). In addition, the TRP-TA configuration includes an association relationship between a tag-Id and a TRP. In the pseudo code shown below, the association relationship includes: a TAG-Id is associated with a TRP corresponding to coresetPoolIndex-r16.

| | |
|---|---|
| tag-IDList | SEQUENCE (SIZE (1..maxNrofTRP-TA-config)) OF |

TRP-TA-Config

| | |
|---|---|
| TRP-TA-config | SEQUENCE { |
| tag-Id | TAG-Id, |
| coresetPoolIndex-r16 | INTEGER (0..1) |

}

In implementation 3, an intermediate variable may be introduced to represent an association relationship between a TAG-Id and a TRP.

The intermediate variable may be denoted by “mTRP-TA-Id”, and may be separately added to “tag-TRP” configuration information and “TRP-TA” configuration information. The “tag-TRP” configuration information may further include a TAG-Id denoted by “tag-Id”, and the “TRP-TA” configuration information may further include coresetPoolIndex-r16. In this way, an association relationship between a TAG whose identity is “tag-Id” and a TRP corresponding to coresetPoolIndex-r16 is established by using the intermediate variable.

| tag-TRP | SEQUENCE { |
|---|---|
| mTRP-TA-Id | mTRP-TA Id, |
| tag-Id | TAG-Id, |
| } | |
| TRP-TA | SEQUENCE { |
| mTRP-TA-Id | mTRP-TA Id, |
| coresetPoolIndex-r16 | INTEGER (0..1) |
| } | |

Certainly, in this embodiment of this application, the intermediate variable “mTRP-TA-Id” may be added to the “tag-TRP” configuration information in another manner. For details, refer to the pseudo code shown below. That is, the intermediate variable “mTRP-TA-Id” may be added to the “tag-TRP” configuration information by being associated with a TRP parameter (denoted by “LinkingtoTRP”). In addition, a manner of adding the intermediate variable to the “TRP-TA” configuration information is similar to that described above. For brevity, details are not described herein again.

| tag-TRP | SEQUENCE { |
|---|---|
| tag-Id | TAG-Id, |
| LinkingtoTRP | mTRP-TA-Id |
| } | |
| TRP-TA | SEQUENCE { |
| mTRP-TA-Id | mTRP-TA Id, |
| coresetPoolIndex-r16 | INTEGER (0..1) |

}

As described above, in this embodiment of this application, the TAG-based TA indication manner may still be used. Therefore, when a TA is configured for the terminal device, a TAG corresponding to the TA may be further indicated, that is, the first information may further include second information used to indicate an identity of the first TAG.

In some implementations, the second information may be the identity of the first TAG. In some other implementations, the second information is bitmap information used to indicate the identity of the first TAG, or bitmap information for the identity of the first TAG is used to indicate whether the first information carries the TA of the first TAG. For example, each bit in a bitmap may correspond to a different TAG. In this way, when a bit is a first value, it may indicate that TAs of one or more TRPs associated with a TAG corresponding to the bit are carried in the first information, and/or a TA of a serving cell associated with a TAG corresponding to the bit is carried in the first information. On the contrary, when a bit is a second value, it may indicate that a TA of a serving cell and/or a TRP associated with a TAG corresponding to the bit is not carried in the first information, where the first value is different from the second value.

For ease of understanding, the following describes, with reference to FIG. 7 to FIG. 8, bearer manners 1 to 2 to which this embodiment of this application is applicable by using an example in which a MAC CE carries the first information. It should be noted that a bearer manner in this embodiment of this application is not limited thereto. In addition, bits occupied by various types of information in the first information are not limited to the following descriptions. For example, a number of bits occupied by a TAG identity may be three bits or four bits.

In the bearer manner 1, a TAG identity may be carried in a MAC CE.

Referring to FIG. 7, it is assumed that a MAC CE includes N bytes, and each byte may include eight bits, where N is a positive integer. Two bits in each byte may be used to carry a TAG identity, and the remaining six bits in each byte may carry a TA command to indicate a TA corresponding to the TAG identity. Generally, a two-bit TAG identity may be used to identify four TAGs.

It should be noted that the two bits indicating the TAG identity may be the first two bits in one byte, or may be the last two bits in one byte. This is not limited in this embodiment of this application. In addition, each of the N bytes included in the MAC CE may be used to indicate a TAG identity and a TA corresponding to the TAG identity. A specific bearer manner is similar to that described above. For brevity, details are not described herein again.

In this embodiment of this application, a conventional manner of indicating a TAG identity and a TA corresponding to the TAG identity (for example, referring to a command format shown in the figure) may be used to improve compatibility with an existing protocol.

In the bearer manner 2, bitmap information indicating a TAG identity may be carried in a MAC CE.

Referring to FIG. 8, it is assumed that a MAC CE includes N bytes, and each byte may include eight bits, where N is a positive integer greater than 1. In the N^{th} byte, six bits may carry a TA command to indicate a TA, and the other two bits may be used as reserved bits (reserve, denoted by “R”). In the (N−1)th byte, four bits may be occupied to carry bitmap information of a TAG identity (denoted by “T”), and the remaining four bits may be used as reserved bits (denoted by “R”). In the four bits that carry the bitmap information, each bit may correspond to one TAG identity. When a bit value in the four bits is set to a first value (for example, “1”), it may indicate that the corresponding TAG identity corresponds to a TA, or a TA of a TAG indicated by the TAG identity is carried in the MAC CE. When a bit value in the four bits is set to a second value (for example, “0”), it may indicate that the corresponding TAG identity does not correspond to a TA, or that a TA of a TAG indicated by the TAG identity is not carried in the MAC CE. The TA of the TAG may include TAs of one or more TRPs associated with the TAG, and/or TAs of one or more serving cells associated with the TAG, and the first value is different from the second value.

It should be noted that the bitmap information used to carry the TAG identity may be determined based on a number of TAG identities. For example, assuming that TAs associated with eight TAGs need to be indicated, eight bits in the MAC CE may be occupied to carry bitmap information of a TAG identity. This embodiment of this application sets no limitation on a number of bits occupied by the bitmap information in the MAC CE.

In this embodiment of this application, a correspondence between a plurality of TAs and identities of a plurality of TAGs may be represented by using bitmap information in one piece of signaling, thereby reducing overheads required for transmitting information indicating a TAG identity.

In addition, in this embodiment of this application, a relatively large number of TAG identities may be carried by using one piece of signaling, thereby improving flexibility of indicating a TAG identity corresponding to a TA. In some cases, a reserved bit may be occupied to carry bitmap information of a TAG identity, to further expand a number of carried TAG identities.

### Embodiment 2

In this embodiment of this application, a TA of a TRP may be directly indicated by using the first information. That is, the first information includes a TA of a first TRP, or the first information includes a first TRP and a TA corresponding to the first TRP.

In some implementations, the first TRP may be identified by using a cell identity of a cell to which the first TRP belongs and/or an identity of the first TRP. In other words, the first information may further include third information and/or fourth information, where the third information is used to indicate the cell identity of the cell to which the first TRP belongs, and the fourth information is used to indicate the identity of the first TRP. The fourth information may be, for example, “CORSETPollIndex”. Certainly, in this embodiment of this application, a TRP may be identified by using other information, for example, a reference signal set (for example, an SRS resource set) or a TRP index. This is not limited in this embodiment of this application.

In some other implementations, the third information may be the cell identity of the cell to which the first TRP belongs; or the third information may be bitmap information used to indicate the cell identity of the cell to which the first TRP belongs, where the bitmap information is used to indicate whether a TA of a TRP in a cell corresponding to a bit is carried in the first information. For example, each bit in a bitmap may correspond to a different cell. In this way, when a bit is a first value, it may indicate that the first information carries a TA of the cell or indicates a TA of at least one TRP configured for the cell. On the contrary, when a bit is a second value, it may indicate that a TA of the cell and a TA of at least one TRP configured for the cell are not carried in the first information, where the first value is different from the second value.

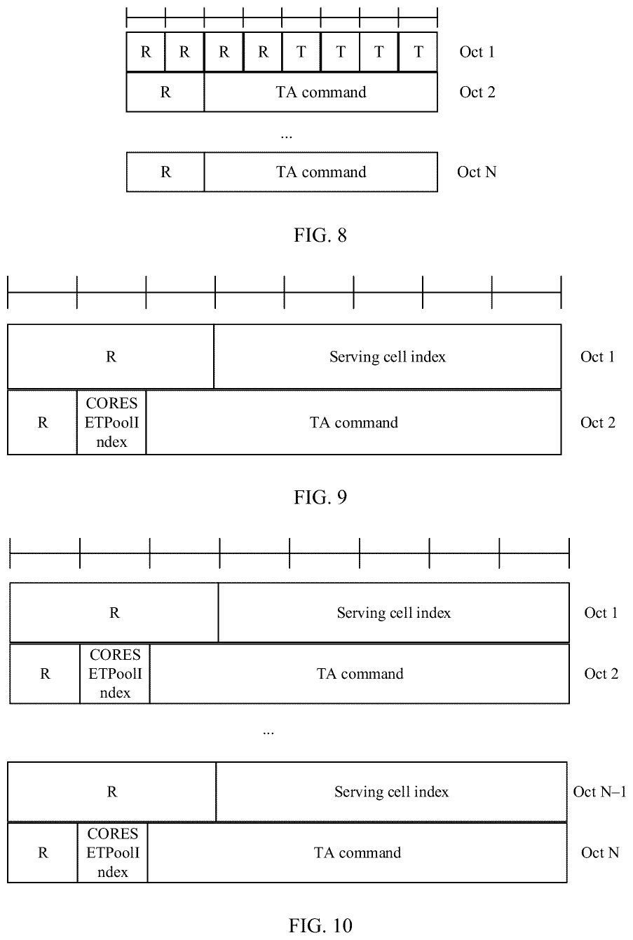

For ease of understanding, the following describes, with reference to FIG. 9 and FIG. 10, bearer manners 3 to 4 to which this embodiment of this application is applicable by using an example in which a MAC CE carries the first information. It should be noted that a bearer manner in this embodiment of this application is not limited thereto.

In the bearer manner 3, the cell identity of the cell to which the first TRP belongs, the identity of the first TRP, and the TA of the first TRP may be carried in the MAC CE.

Referring to FIG. 9, it is assumed that a MAC CE includes two bytes, and each byte may include eight bits. In the first byte (denoted by “Oct 1”), the cell identity of the cell to which the first TRP belongs may occupy five bits, and the remaining bits in the first byte may be used as reserved bits (denoted by “R”). In the second byte (denoted by “Oct 2”), a TA command indicating a TA may occupy six bits, the identity “CORSETPollIndex” of the first TRP may occupy one bit, and the remaining one bit may be used as a reserved bit.

It should be noted that, if one MAC CE needs to be used to indicate TAs corresponding to a plurality of TRPs, a plurality of bytes may be included in the MAC CE. Each two bytes in the plurality of bytes may be used to indicate a TA corresponding to one TRP. As shown in FIG. 10, an information bearer manner may be the same as the information bearer manner in the foregoing Oct 1 and Oct 2. For details, refer to the foregoing descriptions. For brevity, details are not described herein again.

In this embodiment of this application, TAs corresponding to a plurality of TRPs may be represented by using a plurality of bytes in one piece of signaling, thereby reducing overheads required for transmitting information indicating TAs corresponding to a plurality of TRPs.

In the bearer manner 4, the bitmap information indicating the cell to which the first TRP belongs, the identity of the first TRP, and the TA of the first TRP may be carried in the MAC CE.

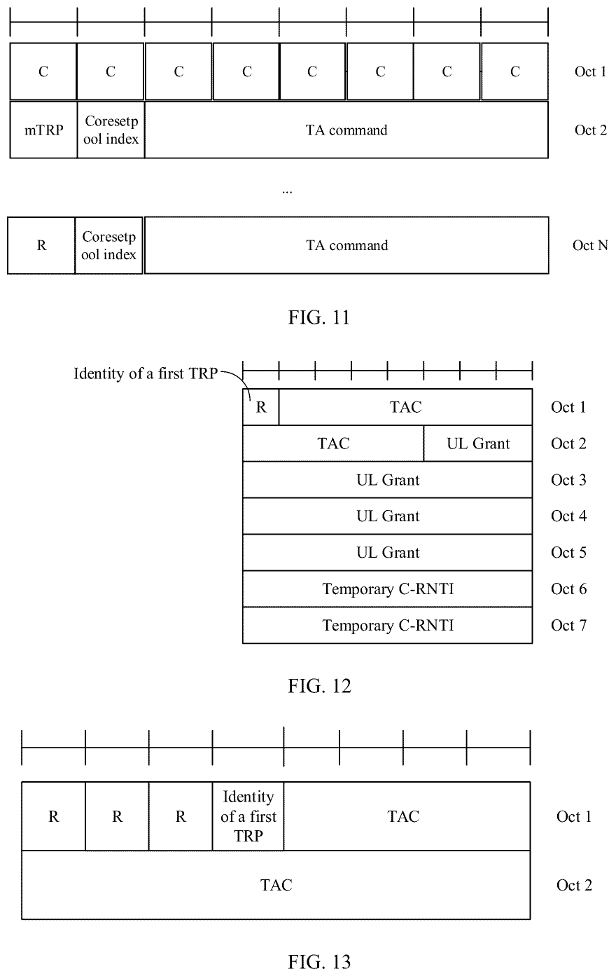

Referring to FIG. 11, it is assumed that a MAC CE includes N bytes, and each byte may include eight bits, where N is a positive integer greater than 1. In the N^{th} byte, a TA command indicating a TA may occupy six bits, the identity “CORSETPollIndex” of the first TRP may occupy one bit, and the remaining one bit may be used to indicate whether a corresponding serving cell is configured with mTRP (denoted by “mTRP”). Generally, when mTRP indicates that the corresponding serving cell is configured with mTRP, it indicates that the serving cell includes a plurality of TRPs. In this case, the MAC CE may carry one or more TA commands to indicate TAs of the plurality of TRPs. On the contrary, when mTRP indicates that the corresponding serving cell is not configured with mTRP, it indicates that the serving cell includes one TRP, or that the serving cell is not configured with mTRP. In this case, the TA command may carry one TA, to indicate a TA of the serving cell.

In the (N−1)^{th} byte (for example, the first byte), eight bits may be occupied to carry the bitmap information (denoted by “C”) for the cell to which the first TRP belongs. Each bit in the eight bits may correspond to one cell. When a bit value in the eight bits is set to a first value (for example, “1”), it may indicate that the MAC CE carries TA information of the cell, and the TA information of the cell may include a TA of the cell and/or a TA of a TRP of the cell. When a bit value in the eight bits is set to a second value (for example, “0”), it may indicate that the MAC CE does not carry TA information of the cell, where the first value is different from the second value.

It should be noted that the bitmap information may occupy eight bits (that is, four bytes) to indicate a cell. In this case, the eight-bit bitmap information may correspond to a maximum of 32 cells.

In some implementations, the cells corresponding to the bitmap information may include some or all serving cells of the terminal device. For example, some serving cells may include the first eight serving cells of the terminal device. For example, all serving cells may include 32 serving cells of the terminal device (in this case, the bitmap information may occupy four bytes). Certainly, the cells corresponding to the bitmap information may further include a serving cell configured with mTRP. This is not limited in this embodiment of this application.

In some other implementations, the cells corresponding to the bitmap information may be sorted in an ascending order or a descending order of cell indexes. For example, as shown in FIG. 11, eight bits that carry bitmap information may correspond to eight cells. In this case, indexes of the corresponding eight cells may be sorted in an ascending manner based on an ascending order of bits. That is, a bit 0 may correspond to a cell index 0, a bit 1 may correspond to a cell index 1, . . . , and a bit 8 may correspond to a cell index 8. Certainly, the indexes of the corresponding eight cells may be sorted in a descending manner based on an ascending order of bits. That is, a bit 0 may correspond to a cell index 8, a bit 1 may correspond to a cell index 7, . . . , and a bit 8 may correspond to a cell index 0. Generally, an index of a primary cell may correspond to the first bit in the eight bits, or an index of a primary cell may correspond to the last bit in the eight bits.

In this embodiment of this application, a cell to which a TRP belongs may be indicated by using bitmap information, thereby reducing a number of bits that are occupied to indicate a cell to which a TRP belongs and that are carried in the first information, so as to reduce overheads required for transmitting information indicating a cell to which a TRP belongs.

The foregoing describes the manner of indicating the first TRP by using the first information with reference to FIG. 9 to FIG. 11. In this embodiment of this application, the first TRP may be indicated in another manner.

In some implementations, the first information may be carried in a RAR. Correspondingly, the terminal device may determine the TA of the first TRP based on the RAR. With reference to FIG. 12 and FIG. 13, the following describes a solution of indicating the TA of the first TRP by using the RAR.

Referring to FIG. 4, a TA value indicated in a conventional RAR is indicated based on each serving cell, and a RAR format shown in FIG. 4 includes one reserved bit. Therefore, in this embodiment of this application, the RAR format shown in FIG. 4 may still be used, and the RAR carries the identity of the first TRP. The identity of the first TRP may occupy a reserved bit in FIG. 4, referring to FIG. 12.

Referring to FIG. 3, a conventional MAC CE format includes four reserved bits. Therefore, in this embodiment of this application, the MAC CE format shown in FIG. 3 may still be used, and a reserved bit in the MAC CE format is occupied to carry the identity of the first TRP. Referring to FIG. 13, one of the four reserved bits may be occupied to transmit information that carries the identity of the first TRP.

In some other implementations, the first information includes information received by the terminal device in a random access procedure, and the first TRP may be determined based on one or more of the following: a resource used in the random access procedure, where different resources may correspond to different TRPs; resource indication information of the resource used in the random access procedure, where the resource indication information of the resource includes information indicating an identity of the first TRP; a TRP to which first uplink data is to be sent, where the random access procedure is triggered by that the first uplink data arrives but the terminal device is in an uplink out-of-synchronization state; or a trigger manner (or referred to as a “trigger type”) of the random access procedure, where the trigger manner of the random access procedure may include a plurality of trigger manners, a cell corresponding to the random access procedure includes a plurality of TRPs, and the plurality of trigger manners are in a one-to-one correspondence with the plurality of TRPs, or different trigger manners correspond to different TRPs.

In some scenarios, for a random access procedure initiated by the terminal device, the network device may configure that each TRP in the plurality of TRPs corresponds to one resource used for random access, and different TRPs may correspond to different resources used for random access. In this way, the terminal device may select a resource corresponding to the first TRP to initiate random access. Correspondingly, the network device may determine the first TRP based on the resource occupied by the random access.

It should be noted that the foregoing resource used for random access may be a resource occupied for transmitting a message 1 (msg1, or referred to as a “preamble”) in a 4-step random access procedure. Certainly, the foregoing resource used for random access may be alternatively a resource occupied for transmitting a message A (msgA) in a 2-step random access procedure. The resource may be one or more of a time domain resource, a frequency domain resource, or a code domain resource. For example, different TRPs may be distinguished by using preambles, or different TRPs may be distinguished by using different random access channel occasions (RO).

In some other scenarios, for a random access procedure initiated by the network device, the network device may add the identity of the first TRP to the resource indication information of the resource used for random access. Correspondingly, the terminal device may determine the first TRP based on the resource indication information. In other words, for the random access procedure triggered by the network device, the network device may send a trigger indication to the terminal device, so as to trigger a random access procedure of the terminal device, where the trigger indication may carry the resource indication information and indicate the first TRP.

In some other scenarios, the random access procedure may be triggered by that the first uplink data arrives but the terminal device is in an uplink out-of-synchronization state. The terminal device may determine, based on a logical channel or a logical channel group to which the first uplink data belongs, the TRP to which the first uplink data is to be sent. In other words, the first TRP may be determined based on the TRP to which the first uplink data is to be sent.

In some other scenarios, the plurality of TRPs may be in a one-to-one correspondence with the plurality of trigger manners of the random access procedure. Therefore, the terminal device may determine the first TRP based on the trigger manner of the random access procedure. In some implementations, the plurality of trigger manners may include triggering the random access procedure by using a MAC layer procedure; and/or triggering the random access procedure by using a physical layer procedure.

Triggering the random access procedure by using a MAC layer procedure may be understood as a random access procedure triggered by a MAC entity, for example, contention based random access (CBRA). Triggering the random access procedure by using a physical layer procedure may be understood as a random access procedure triggered based on a PDCCH command.

For example, TRPs included in each serving cell may be classified into a primary TRP and a secondary TRP. For the primary TRP, the terminal device may initiate CBRA. For the secondary TRP, the terminal device may trigger a random access procedure based on a PDCCH command. In other words, the primary TRP and the secondary TRP in the serving cell may correspond to trigger manners of different random access procedures. Therefore, the first TRP may be determined based on the trigger manner of the random access procedure.

For another example, TRPs in a remaining SCell or PCell are secondary TRPs other than a primary TRP of a primary cell. For the primary TRP of the primary cell, the terminal device may initiate CBRA. For the remaining secondary TRP, the terminal device needs to trigger a random access procedure based on a PDCCH command. In this case, the terminal device may determine the first TRP after receiving a RAR.

It should be noted that the primary TRP and the secondary TRP may be configured by the network device, or the primary TRP and the secondary TRP may be distinguished by using a default rule. For example, coresetpool 1 may correspond to the primary TRP, and coresetpool 2 may correspond to the secondary TRP. This is not limited in this embodiment of this application.

In this embodiment of this application, the foregoing manner of determining the first TRP can reduce overheads occupied by the network device to indicate the first TRP.

It should be noted that the TA described above may be a TA adjustment value or an absolute TA, and the absolute TA may be a value N_{TA}. This is not limited in this embodiment of this application. In this embodiment of this application, an indication manner of the TA adjustment value may be used in combination with an indication manner of the absolute TA. For example, when the TA is a TA adjustment value in the indication manners described above with reference to FIG. 7 to FIG. 11 and the TA is an absolute TA in the indication manners described above with reference to FIG. 12 and FIG. 13, any indication manner described in FIG. 7 to FIG. 11 may be used in combination with any indication manner described in FIG. 12 and FIG. 13 to configure a TA for the terminal device. Usage of the TA adjustment value and the absolute TA is described in detail in the foregoing description of the TA. For brevity, details are not described herein again.

Currently, validity of a TA is generally maintained by using a TA timer (also referred to as a “first timer”). When the TA timer expires, the corresponding TA fails (or is invalid), and the terminal device cannot communicate with a corresponding TRP based on the invalid TA in this case. On the contrary, when the TA timer does not expire, the corresponding TA is valid, and the terminal device may communicate with a corresponding TRP based on the valid TA in this case. In the solution in this embodiment of this application, after a TA is configured by using a TRP as a granularity, to reduce a number of TA timers corresponding to TAs, one TA timer may correspond to TAs of a plurality of TRPs. Certainly, if a number of TA timers is not considered, one timer may be configured for a TA of each TRP.

In other words, the foregoing method further includes: starting or restarting, by the terminal device, a first timer based on the first information, where the first timer is used to maintain validity of the TAs of the one or more TRPs. In some implementations, TAs of a plurality of TRPs in a serving cell may be classified into one or more groups, each group includes one or more TAs, and TAs in each group may correspond to one timer.

It should be noted that the starting or restarting, by the terminal device, a first timer based on the first information may include: starting or restarting, by the terminal device, the first timer when receiving the first information. In other words, that the terminal device receives the first information may be used as a trigger condition for starting or restarting the first timer. Correspondingly, after receiving the first information, the terminal device may apply a TA indicated in the first information.

It should be noted that if a TA of a TRP is indicated by using a TAG (for example, the solution described in Embodiment 1), the first timer may be associated with one or more TAGs. If a TA of a TRP is directly indicated (for example, the solution described in Embodiment 2), the first timer may be associated with one or more TRPs.

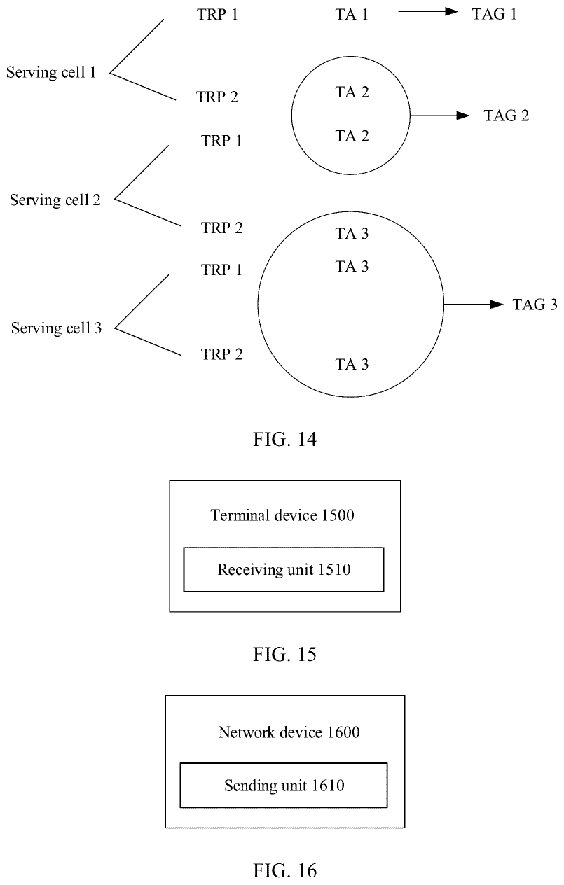

For ease of understanding, the following describes an association relationship between a TA and a timer in this embodiment of this application with reference to FIG. 14. Referring to FIG. 14, it is assumed that serving cells of the terminal device include a serving cell 1, a serving cell 2, and a serving cell 3, and the foregoing three serving cells are configured with mTRP. TRPs included in the serving cell 1 are a TRP 1 and a TRP 2, TRPs included in the serving cell 2 are a TRP 1 and a TRP 2, and TRPs included in the serving cell 3 are a TRP 1 and a TRP 2.

Correspondingly, a TA 1 of the TRP 1 of the serving cell 1 is associated with a TAG 1, a TA 2 of the TRP 2 of the serving cell 1 and a TA 2 of the TRP 1 of the serving cell 2 may be associated with a TAG 2, and a TA 3 of the TRP 2 of the serving cell 2 and TAs 3 of all TRPs of the serving cell 3 may be associated with a TAG 3.

In an example, a unique ID (for example, mTRP-TA-Id) in a cell group may be configured for a TRP in each serving cell, and each ID may be associated with a configuration of a timer, so that a plurality of IDs can be associated with a same timer configuration by establishing an association relationship between an ID and a timer. Correspondingly, when a TA is adjusted, an ID may be used for identification. The ID may be an identity of a serving cell and coresetpool ID mentioned above.

Correspondingly, pseudo code corresponding to TRP-TA information of the added unique ID “mTRP-TA-Id” may be as follows. The TRP-TA information indicates a TRP corresponding to a TA.

| | |
|---|---|
| TRP-TA | SEQUENCE { |
| mTRP-TA-Id | mTRP-TA Id, |
| coresetPoolIndex-r16 | INTEGER (0..1) |

}

Pseudo code corresponding to TA information of the added unique ID “mTRP-TA-Id” may be as follows. The TA information further includes a TA timer identity (denoted by “TA-Timer-ID”). In addition, the TA timer identity is used to identify a TA timer configuration (denoted by “TA-Timer-Config”), where the TA timer configuration includes a TA timer identity and a TA timer (denoted by “TimeAlignmentTimer”). Duration corresponding to the TA timer may be listed in an enumeration manner, including {500 ms, 750 ms, 1280 ms, 1920 ms, 2560 ms, 5120 ms, 10240 ms, infinity}.

| | |
|---|---|
| TA ::= | SEQUENCE { |
| mTRP-TA-Id | mTRP-TA Id, |
| ta-timer-ID | TA-Timer-ID, |

```
    ...
  }
```

| | |
|---|---|
| TA-Timer-Config ::= | SEQUENCE { |
| ta-timer-ID | TA-Timer-ID, |
| timeAlignmentTimer | TimeAlignmentTimer, |

```
    ...
  }
```

| | |
|---|---|
| TimeAlignmentTimer ::= | ENUMERATED {ms500, ms750, |

ms1280, ms1920, ms2560, ms5120, ms10240, infinity}

In some implementations, if the first timer expires, a target operation is triggered. The target operation includes one or more of the following operations: flushing a hybrid automatic repeat request (HARQ) buffer; notifying radio resource control (RRC) to release an uplink resource (the uplink resource may include, for example, a PUCCH, an SRS, a cell group (CG), a PUSCH, and semi-persistent scheduling (SPS)); maintaining a timing advance absolute value; initiating a random access procedure; or retransmitting data in the HARQ buffer by using a TRP whose TA is valid. Certainly, in some other implementations, if the first timer expires, the terminal device may not perform the foregoing target operation.

In some scenarios (for example, a serving cell is configured with mTRP), when the first timer expires, a TA corresponding to the first timer fails. In this case, a TA of another TRP in the serving cell may be valid. Therefore, the data in the HARQ buffer may be retransmitted by using the TRP whose TA is valid. In this way, after the first timer fails, the terminal device may directly retransmit the data in the HARQ buffer by using the TRP whose TA is valid, without initiating a random access procedure, thereby reducing a delay required for communication between the terminal device and a TRP.

In a scenario similar to the above, a plurality of TRPs in the serving cell may correspond to a plurality of TAs. When the first timer expires, the TA corresponding to the first timer fails. In this case, a TA of another TRP in the serving cell may be valid. Therefore, the terminal device may not perform any target operation.

It should be noted that the target operation may further include one or more operations specified in an existing protocol. For example, the target operation may include one or more of the following operations: clearing a configured downlink assignment and an uplink grant; clearing a PUSCH resource for semi-persistent CSI reporting; or considering all running TA timers as expired.

In different scenarios, the target operation may be performed for different objects. In some implementations, if the first timer may be associated with one or more TAGs in the TAG-based TA indication manner (for example, the solution in Embodiment 1), the target operation is performed for one or more of the following objects: all serving cells of the terminal device; a TRP associated with each of one or more TAGs; or a serving cell in which the TRP associated with each of the one or more TAGs is located.

All the serving cells of the terminal device may be all serving cells to which the terminal device establishes a connection, or may include all serving cells in a serving cell list of the terminal device, or may include all serving cells that communicate with the terminal device. This is not limited in this embodiment of this application.

If the object for which the target operation is performed includes the TRP associated with each of the one or more TAGs, the target operation may include flushing a HARQ buffer associated with the TRP included in each of the one or more TAGs. For example, for a serving cell configured with a plurality of TRPs, each TRP in the serving cell may have one HARQ entity, and a HARQ procedure in each HARQ entity may belong to a different TRP. In this case, the target operation may include flushing a HARQ buffer corresponding to a HARQ procedure associated with the TRP included in each of the one or more TAGs.

For another example, for a serving cell configured with a plurality of TRPs, each serving cell may have one HARQ entity, and a HARQ procedure in the HARQ entity may be divided into a plurality of groups, where the plurality of groups are associated with a plurality of TRPs. In this case, the target operation may include flushing a HARQ buffer corresponding to a HARQ procedure in a group associated with the TRP included in each of the one or more TAGs.

If the object for which the target operation is performed includes the TRP associated with each of the one or more TAGs, the target operation includes notifying RRC to release an uplink resource. Generally, for a serving cell configured with a plurality of TRPs, each TRP in the serving cell may be configured with a corresponding uplink resource. Therefore, the target operation may include notifying the RRC to release an uplink resource corresponding to the TRP associated with each of the one or more TAGs.

It should be noted that the foregoing TAG may be a primary timing advance group (PTAG) or a secondary timing advance group (STAG). This is not limited in this embodiment of this application. The PTAG may be understood as a TAG that includes a Spcell (a PCell or a PSCell). Correspondingly, all other TAGs except the PTAG may be STAGs.

In some other implementations, when a TA of a TRP is directly indicated (for example, the solution in Embodiment 2), if the first timer may be associated with one or more TRPs, the target operation is performed for one or more of the following objects: all serving cells of the terminal device; the one or more TRPs; or a serving cell in which each of the one or more TRPs is located.

When the object for which the target operation is performed includes one or more TRPs, the target operation may include flushing a HARQ buffer associated with each of the one or more TRPs. For example, for a serving cell configured with a plurality of TRPs, each TRP in the serving cell may have one HARQ entity, and a HARQ procedure in each HARQ entity may belong to a different TRP. In this case, the target operation may include flushing a HARQ buffer corresponding to a HARQ procedure associated with each of the one or more TRPs.

For another example, for a serving cell configured with a plurality of TRPs, each serving cell may have one HARQ entity, and a HARQ procedure in the HARQ entity may be divided into a plurality of groups, where the plurality of groups are associated with a plurality of TRPs. In this case, the target operation may include flushing a HARQ buffer corresponding to a HARQ procedure in a group associated with each of the one or more TRPs.

If the object for which the target operation is performed includes one or more TRPs, the target operation includes notifying RRC to release an uplink resource. Generally, for a serving cell configured with a plurality of TRPs, each TRP in the serving cell may be configured with a corresponding uplink resource. Therefore, the target operation may include notifying the RRC to release an uplink resource corresponding to each of the one or more TRPs.

It should be noted that the foregoing TAG may be a PTAG or an STAG. This is not limited in this embodiment of this application.

As described above, in the TAG-based TA indication solution, a TAG may be associated with a serving cell, or may be associated with one or more TRPs. When a TAG is associated with one or more TRPs, for behavior of the terminal device (including performing the target operation and not performing the target operation), refer to the foregoing descriptions. When a TAG is associated with only a serving cell, an operation that may be performed by the terminal device is described below.

After a TA timer associated with a TAG expires, if the TAG is a PTAG, a corresponding operation may be performed on all serving cells. The operation performed by the terminal device may include one or more of the following: flushing HARQ buffers of all the serving cells; for a serving cell configured with a PUCCH, notifying RRC to release PUCCHs of all the serving cells; for a serving cell configured with an SRS, notifying the RRC to release SRSs of all the serving cells; clearing a configured downlink assignment and an uplink grant; clearing a PUSCH resource for semi-persistent CSI reporting; considering all running TA timers as expired; or maintaining N_{TA} (the parameter defined in TS 38.211 [8]) of all TAGs.

If the foregoing TAG is an STAG, a corresponding operation may be performed on a serving cell associated with the STAG. The operation performed by the terminal device may include one or more of the following: flushing a HARQ buffer; for a serving cell configured with a PUCCH, notifying RRC to release the PUCCH; for a serving cell configured with an SRS, notifying the RRC to release the SRS; clearing a configured downlink assignment and an uplink grant; clearing a PUSCH resource for semi-persistent CSI reporting; considering a running TA timer as expired; or maintaining N_{TA} (the parameter defined in the TS 38.211 [8]) of the foregoing TAG (that is, the STAG). It should be noted that regardless of whether a TAG is associated with a serving cell or one or more TRPs, the operation may be determined based on whether a cell is configured with mTRP. Certainly, the operation may be determined based on another manner, for example, pre-defined or preconfigured in a protocol. This is not limited in this embodiment of this application.

When a TAG is associated with one or more TRPs and is further associated with one or more serving cells, an operation to be performed by the terminal device may be distinguished based on whether the TRP is associated with a TAG or a serving cell. In other words, if a TAG is associated with one or more TRPs and is further associated with one or more serving cells, for the one or more TRPs associated with the TAG, an operation to be performed by the terminal device is described with reference to the foregoing descriptions.

In some implementations, the terminal device may further perform the target operation based on a type of a serving cell to which each of the one or more TRPs belongs, where the type of the serving cell may be associated with the target operation. For example, different types of serving cells may be associated with different target operations. Certainly, different types of serving cells may alternatively be associated with a same target operation. This is not specifically limited in this embodiment of this application.

The type of the serving cell may include a primary cell, a secondary cell, a primary secondary cell, and the like. This is not limited in this embodiment of this application.

In some other implementations, the terminal device may further perform a target operation on an object (also referred to as the “object of the target operation”) based on a type of a serving cell to which each of the one or more TRPs belongs. The type of the serving cell may be associated with the object of the target operation. For example, different types of serving cells may be associated with objects of different target operations. Certainly, different types of serving cells may alternatively be associated with an object of a same target operation. This is not limited in this embodiment of this application. For ease of understanding, the following provides descriptions by using an example in which the type of the serving cell includes a primary cell and a secondary cell.

When a type of a serving cell to which a TRP belongs is a primary cell, the object of the target operation performed by the terminal device may be all serving cells of the terminal device. When a type of a serving cell to which a TRP belongs is a secondary cell, the object of the target operation performed by the terminal device may be the TRP.

In an example in which a serving cell to which a TRP belongs is a serving cell 2, if a type of the serving cell 2 is a primary cell, the object of the target operation performed by the terminal device may be all serving cells or the TRP. If a type of the serving cell 2 is a secondary cell, the object of the target operation performed by the terminal device may be the TRP or the serving cell 2.

When a TAG is associated with one or more TRPs and is further associated with one or more serving cells, for a first serving cell associated with the TAG, the terminal device may perform a corresponding operation (also referred to as a first operation) on the associated first serving cell. The operation performed by the terminal device may include one or more of the following: flushing a HARQ buffer of the first serving cell; if the first serving cell is configured with a PUCCH, notifying RRC to release the PUCCH of the first serving cell; if the first serving cell is configured with an SRS, notifying the RRC to release the SRS of the first serving cell; clearing a configured downlink assignment and an uplink grant; clearing a PUSCH resource for semi-persistent CSI reporting; considering all running TA timers as expired; or maintaining N_{TA} (the parameter defined in TS 38.211 [8]) of the foregoing TAG.

For example, if a TAG 1 is associated with a TRP 1 of a serving cell 2 and a serving cell 1, after a timer associated with the TAG 1 expires, for an operation performed by the terminal device for the TPR 1, refer to the foregoing descriptions. For the serving cell 1, the terminal device may perform a corresponding operation on the serving cell 1. The operation performed by the terminal device may include one or more of the following: flushing a HARQ buffer of the serving cell 1; if the serving cell 1 is configured with a PUCCH, notifying RRC to release the PUCCH of the serving cell 1; if the serving cell 1 is configured with an SRS, notifying the RRC to release the SRS of the serving cell 1; clearing a configured downlink assignment and an uplink grant; clearing a PUSCH resource for semi-persistent CSI reporting; considering all running TA timers as expired; or maintaining N_{TA} (the parameter defined in TS 38.211 [8]) of the foregoing TAG.

In some implementations, the terminal device may further perform a first operation based on a type of a first serving cell, where the type of the first serving cell may be associated with the first operation. For example, different types of serving cells may be associated with different first operations. Certainly, different types of serving cells may alternatively be associated with a same first operation. This is not specifically limited in this embodiment of this application.

The type of the serving cell may include a primary cell, a secondary cell, a primary secondary cell, and the like. This is not limited in this embodiment of this application. For ease of understanding, the following provides descriptions by using an example in which the type of the serving cell includes a primary cell and a secondary cell.

In some other implementations, the terminal device may further perform a first operation on an object based on a type of a first serving cell, where the type of the serving cell may be associated with the object of the first operation. For example, different types of serving cells may be associated with different objects. Certainly, different types of serving cells may alternatively be associated with a same object. This is not limited in this embodiment of this application. For ease of understanding, the following provides descriptions by using an example in which the type of the serving cell includes a primary cell and a secondary cell.

If a type of a serving cell 1 is a primary cell, the terminal device may perform the first operation on all serving cells. If the type of the serving cell 1 is a secondary cell, the terminal device may perform the first operation only on the serving cell 1.

When a TAG is associated with one or more TRPs and is further associated with one or more serving cells, for the one or more TRPs associated with the TAG, the terminal device may perform different target operations and/or perform a target operation on objects of different target operations based on whether an associated serving cell is associated with a plurality of TRPs (or whether the associated serving cell is configured with mTRP) and/or a type of the serving cell. Certainly, in this embodiment of this application, the terminal device may alternatively perform different target operations and/or perform a target operation on objects of different target operations based on a number of TRPs whose TAs are invalid in a plurality of TRPs associated with the serving cell. For example, if a serving cell is associated with a plurality of TRPs and a type of the serving cell is a primary cell, when a timer associated with a TAG corresponding to each TRP stops or expires, the terminal device may perform a target operation on all serving cells.

For another example, if a serving cell is associated with a plurality of TRPs and a type of the serving cell is a secondary cell, when a timer associated with a TAG corresponding to each TRP stops or expires, the terminal device may perform a target operation on the current serving cell.

For another example, if a serving cell is associated with a plurality of TRPs, when a timer associated with a TAG corresponding to at least one of the plurality of TRPs is running, an object of the target operation of the terminal device may include only a TRP to which a TA of the running timer belongs. It should be understood that, in this embodiment of this application, the type of the serving cell, whether the serving cell is configured with multi-TRP, and a number of TRPs whose TAs are invalid may be separately used to determine an operation or an object of an operation performed by the terminal device. Certainly, some or all of the foregoing three conditions may be randomly combined to determine an operation or an object of an operation performed by the terminal device, or the foregoing three conditions may be further combined with another condition to determine an operation or an object of an operation performed by the terminal device. This is not limited in this embodiment of this application.

In addition, after the terminal device performs the target operation, the network device may also perform a corresponding operation. For example, a target operation that may be performed by the network device may also include one or more of the following operations: clearing data received by the network device and sent by using a HARQ buffer; releasing an uplink resource (the uplink resource may include, for example, a PUCCH, an SRS, a CG, a PUSCH, and SPS); maintaining a timing advance absolute value; initiating a random access procedure; or maintaining data, where the data includes data in a HARQ buffer retransmitted by using a TRP whose TA is valid. In addition, the target operation performed by the network device may be performed on different objects in different scenarios. For a specific division manner, refer to the objects on which the target operation is performed by the terminal device in different scenarios. For brevity, details are not described below. Certainly, in this embodiment of this application, the network device may not perform any target operation.

To be compatible with a scenario in which no mTRP is configured for a serving cell, the first information may also be applicable to the scenario in which no mTRP is configured for a serving cell. For example, when a serving cell of the terminal device is configured with mTRP, the first information is used to indicate TAs of one or more TRPs, and the one or more TRPs belongs to a serving cell configured with mTRP. On the contrary, when no mTRP is configured for one or more serving cells of the terminal device, the first information is used to indicate TAs of the one or more serving cells. Certainly, in this embodiment of this application, the first information may also be applicable to only a scenario in which a serving cell is configured with mTRP.

The method embodiments of this application are described in detail above with reference to FIG. 1 to FIG. 14. Apparatus embodiments of this application are described below in detail with reference to FIG. 15 to FIG. 17. It should be understood that the descriptions of the method embodiments correspond to the descriptions of the apparatus embodiments, and therefore, for a part that is not described in detail, reference may be made to the foregoing method embodiments.

FIG. 15 is a schematic diagram of a terminal device according to an embodiment of this application. The terminal device 1500 shown in FIG. 15 includes a receiving unit 1510.

The receiving unit 1510 is configured to receive first information, where the first information is used to indicate TAs of one or more TRPs.

In a possible implementation, the first information includes TA of a first TAG, and the first TAG is associated with the one or more TRPs.

In a possible implementation, an association relationship between the first TAG and the one or more TRPs is determined based on configuration information of a network device.

In a possible implementation, the configuration information of the network device is configuration information of a serving cell of the terminal device, where configuration information of each serving cell of the terminal device includes identities of a plurality of TAGs, and the identities of the plurality of TAGs are separately associated with a plurality of TRPs.

In a possible implementation, an association relationship between the identities of the plurality of TAGs and the plurality of TRPs is a default association relationship; or an association relationship between the identities of the plurality of TAGs and the plurality of TRPs is indicated by the configuration information of each serving cell.

In a possible implementation, the first information further includes second information used to indicate an identity of the first TAG.

In a possible implementation, the second information is the identity of the first TAG; or the second information is bitmap information used to indicate the identity of the first TAG.

In a possible implementation, the first information includes a TA of a first TRP.

In a possible implementation, the first information further includes third information and/or fourth information, where the third information is used to indicate a cell identity of a cell to which the first TRP belongs, and the fourth information is used to indicate an identity of the first TRP.

In a possible implementation, the third information is the cell identity of the cell to which the first TRP belongs; or the third information is bitmap information indicating the cell identity of the cell to which the first TRP belongs.

In a possible implementation, the first information includes information received by the terminal device in a random access procedure, and the first TRP is determined based on one or more of the following: a resource used in the random access procedure, where different resources correspond to different TRPs; resource indication information of the resource used in the random access procedure, where the resource indication information of the resource includes information indicating an identity of the first TRP; a TRP to which first uplink data is to be sent, where the random access procedure is triggered by that the first uplink data arrives but the terminal device is in an uplink out-of-synchronization state; or a trigger manner of the random access procedure, where a cell corresponding to the random access procedure includes a plurality of TRPs, and different trigger manners correspond to different TRPs in the plurality of TRPs.

In a possible implementation, the resource in the random access procedure includes a resource used for transmitting a msg1 in the random access procedure or a resource used for transmitting a msgA in the random access procedure.

In a possible implementation, the trigger manner includes at least one of the following: triggering the random access procedure by using a MAC layer procedure; or triggering the random access procedure by using a physical layer procedure.

In a possible implementation, validity of the TAs of the one or more TRPs is maintained by a first timer.

In a possible implementation, if the first timer expires, the terminal device performs or does not perform a target operation, where the target operation includes one or more of the following operations: flushing a HARQ buffer; notifying RRC to release an uplink resource; maintaining a timing advance absolute value; initiating a random access procedure; or retransmitting data in the HARQ buffer by using a TRP whose TA is valid.

In a possible implementation, if the first timer is associated with one or more TAGs, the target operation is performed for one or more of the following objects: all serving cells of the terminal device; a TRP associated with each of the one or more TAGs; a serving cell in which the TRP associated with each of the one or more TAGs is located; or a serving cell associated with at least one TAG.

In a possible implementation, if the first timer is associated with one or more TRPs, the target operation is performed for one or more of the following objects: all serving cells of the terminal device; the one or more TRPs; or a serving cell in which each of the one or more TRPs is located.

In a possible implementation, the first timer is associated with one or more TAGs; or the first timer is associated with one or more TRPs.

In a possible implementation, a TAG in the first information includes a PTAG and/or an STAG.

In a possible implementation, the first information is carried in a MAC PDU or DCI.

In a possible implementation, when a serving cell of the terminal device is configured with mTRP, the first information is used to indicate the TAs of the one or more TRPs, and the one or more TRPs belong to the serving cell configured with the mTRP.

In a possible implementation, when one or more serving cells of the terminal device are not configured with mTRP, the first information is used to indicate TAs of the one or more serving cells.

FIG. 16 is a schematic diagram of a network device according to an embodiment of this application. The network device shown in FIG. 16 includes a sending unit 1610.

The sending unit 1610 is configured to send first information, where the first information is used to indicate TAs of one or more TRPs.

In a possible implementation, the first information includes TA of a first TAG, and the first TAG is associated with the one or more TRPs.

In a possible implementation, an association relationship between the first TAG and the one or more TRPs is determined based on configuration information of the network device.

In a possible implementation, the configuration information of the network device is configuration information of a serving cell of a terminal device, where configuration information of each serving cell of the terminal device includes identities of a plurality of TAGs, and the identities of the plurality of TAGs are separately associated with a plurality of TRPs.

In a possible implementation, an association relationship between the identities of the plurality of TAGs and the plurality of TRPs is a default association relationship; or an association relationship between the identities of the plurality of TAGs and the plurality of TRPs is indicated by the configuration information of each serving cell.

In a possible implementation, the first information further includes second information used to indicate an identity of the first TAG.

In a possible implementation, the second information is the identity of the first TAG; or the second information is bitmap information used to indicate the identity of the first TAG.

In a possible implementation, the first information includes a TA of a first TRP.

In a possible implementation, the first information further includes third information and/or fourth information, where the third information is used to indicate a cell identity of a cell to which the first TRP belongs, and the fourth information is used to indicate an identity of the first TRP.

In a possible implementation, the third information is the cell identity of the cell to which the first TRP belongs; or the third information is bitmap information indicating the cell identity of the cell to which the first TRP belongs.

In a possible implementation, the first information includes information received by the terminal device in a random access procedure, and the first TRP is determined based on one or more of the following: a resource used in the random access procedure, where different resources correspond to different TRPs; resource indication information of the resource used in the random access procedure, where the resource indication information of the resource includes information indicating an identity of the first TRP; a TRP to which first uplink data is to be sent, where the random access procedure is triggered by that the first uplink data arrives but the terminal device is in an uplink out-of-synchronization state; or a trigger manner of the random access procedure, where a cell corresponding to the random access procedure includes a plurality of TRPs, and different trigger manners correspond to different TRPs in the plurality of TRPs.

In a possible implementation, the resource in the random access procedure includes a resource used for transmitting a msg1 in the random access procedure or a resource used for transmitting a msgA in the random access procedure.

In a possible implementation, the trigger manner includes at least one of the following: triggering the random access procedure by using a MAC layer procedure; or triggering the random access procedure by using a physical layer procedure.

In a possible implementation, validity of the TAs of the one or more TRPs is maintained by a first timer.

In a possible implementation, if the first timer expires, the terminal device performs or does not perform a target operation, where the target operation includes one or more of the following operations: flushing a HARQ buffer; notifying RRC to release an uplink resource; maintaining a timing advance absolute value; initiating a random access procedure; or retransmitting data in the HARQ buffer by using a TRP whose TA is valid.

In a possible implementation, if the first timer is associated with one or more TAGs, the target operation is performed for one or more of the following objects: all serving cells of the terminal device; a TRP associated with each of the one or more TAGs; a serving cell in which the TRP associated with each of the one or more TAGs is located; or a serving cell associated with at least one TAG.

In a possible implementation, if the first timer is associated with one or more TRPs, the target operation is performed for one or more of the following objects: all serving cells of the terminal device; the one or more TRPs; or a serving cell in which each of the one or more TRPs is located.

In a possible implementation, the first timer is associated with one or more TAGs; or the first timer is associated with one or more TRPs.

In a possible implementation, a TAG in the first information includes a PTAG and/or an STAG.

In a possible implementation, the first information is carried in a MAC PDU or DCI.

In a possible implementation, when a serving cell of the terminal device is configured with mTRP, the first information is used to indicate the TAs of the one or more TRPs, and the one or more TRPs belong to the serving cell configured with the mTRP.

In a possible implementation, when one or more serving cells of the terminal device are not configured with mTRP, the first information is used to indicate TAs of the one or more serving cells.

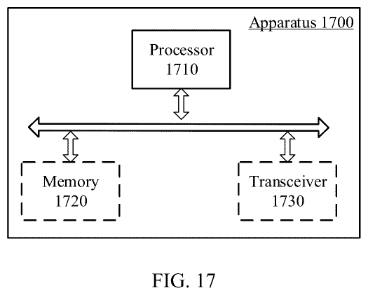

In an optional embodiment, the receiving unit 1510 may be a transceiver 1740. The terminal device may further include a processor 1710 and a memory 1720, which are specifically shown in FIG. 17.

In an optional embodiment, the sending unit 1610 may be a transceiver 1740. The network device may further include a processor 1710 and a memory 1820, which are specifically shown in FIG. 17.

FIG. 17 is a schematic structural diagram of an apparatus according to an embodiment of this application. Dashed lines in FIG. 17 indicate that units or modules are optional. The apparatus 1700 may be configured to implement the methods described in the foregoing method embodiments. The apparatus 1700 may be a chip, a terminal device, or a network device.

The apparatus 1700 may include one or more processors 1710. The processor 1710 may allow the apparatus 1700 to implement the methods described in the foregoing method embodiments. The processor 1710 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1700 may further include one or more memories 1720. The memory 1720 stores a program. The program may be executed by the processor 1710, to cause the processor 1710 to execute the methods described in the foregoing method embodiments. The memory 1720 may be independent of the processor 1710 or may be integrated into the processor 1710.

The apparatus 1700 may further include a transceiver 1730. The processor 1710 may communicate with another device or chip through the transceiver 1730. For example, the processor 1710 may send data to and receive data from another device or chip through the transceiver 1730.

An embodiment of this application further provides a computer-readable storage medium for storing a program. The computer-readable storage medium may be applied to the terminal device or the network device provided in embodiments of this application, and the program causes a computer to execute a method to be executed by the terminal device or the network device in embodiments of this application.

An embodiment of this application further provides a computer program product. The computer program product includes a program. The computer program product may be applied to the terminal device or the network device provided in embodiments of this application, and the program causes a computer to execute a method to be executed by the terminal device or the network device in embodiments of this application.

An embodiment of this application further provides a computer program. The computer program may be applied to the terminal device or the network device provided in embodiments of this application, and the computer program causes a computer to execute a method to be executed by the terminal device or the network device in embodiments of this application.

It should be understood that, in embodiments of this application, if the method is applied to a carrier aggregation scenario, the foregoing serving cell may be replaced with a component carrier (CC).

In addition, “B corresponding to (or associated with) A” indicates that B is associated with A, and B may be determined based on A. However, it should also be understood that, determining B based on A does not mean determining B based only on A, but instead B may be determined based on A and/or other information.

It should be understood that, in this specification, the term “and/or” merely describes an association relationship between associated objects, and represents that there may be three relationships. For example, A and/or B may represent three cases: only A exists, both A and B exist, and only B exists. In addition, the character “/” in this specification generally indicates an “or” relationship between the associated objects.

It should be understood that in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may be or may not be physically separate, and components displayed as units may be or may not be physical units, that is, may be located in one place or distributed on a plurality of network units. Some or all of the units may be selected according to actual needs to achieve the objectives of the solutions of embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A terminal device, comprising a transceiver, a memory, and a processor, wherein the memory is configured to store a program, and the processor is configured to invoke the program in the memory to send and receive information through the transceiver, to cause the terminal to execute the method comprising:
receiving first information, wherein the first information is used to indicate timing advances TAs of one or more transmitting and receiving points TRPs.

2. The terminal device according to claim 1, wherein the first information comprises a TA of a first timing advance group TAG, and the first TAG is associated with the one or more TRPs.

3. The terminal device according to claim 2, wherein an association relationship between the first TAG and the one or more TRPs is determined based on configuration information of a network device.

4. The terminal device according to claim 3, wherein the configuration information of the network device is configuration information of a serving cell of the terminal device, wherein configuration information of each serving cell of the terminal device comprises identities of a plurality of TAGs, and the identities of the plurality of TAGs are separately associated with a plurality of TRPs.

5. The terminal device according to claim 2, wherein the first information further comprises second information used to indicate an identity of the first TAG.

6. The terminal device according to claim 5, wherein the second information is the identity of the first TAG; or the second information is bitmap information used to indicate the identity of the first TAG.

7. The terminal device according to claim 1, wherein the first information comprises a TA of a first TRP.

8. The terminal device according to claim 7, wherein the first information comprises information received by the terminal device in a random access procedure, and the first TRP is determined based on one or more of following:
a resource used in the random access procedure, wherein different resources correspond to different TRPs;
resource indication information of the resource used in the random access procedure, wherein the resource indication information of the resource comprises information indicating an identity of the first TRP;
a TRP to which first uplink data is to be sent, wherein the random access procedure is triggered by that the first uplink data arrives but the terminal device is in an uplink out-of-synchronization state; or
a trigger manner of the random access procedure, wherein a cell corresponding to the random access procedure comprises a plurality of TRPs, and different trigger manners correspond to different TRPs in the plurality of TRPs.

9. The terminal device according to claim 8, wherein the resource in the random access procedure comprises a resource used for transmitting a message 1 in the random access procedure or a resource used for transmitting a message A in the random access procedure.

10. The terminal device according to claim 1, wherein the method further comprises:
starting or restarting, by the terminal device, a first timer based on the first information, wherein the first timer is used to maintain validity of the TAs of the one or more TRPs.

11. The terminal device according to claim 10, wherein if the first timer expires, the terminal device performs or does not perform a target operation, wherein the target operation comprises one or more of following operations:
flushing a HARQ buffer;
notifying RRC to release an uplink resource;
maintaining a timing advance absolute value;
initiating a random access procedure; or
retransmitting data in the HARQ buffer by using a TRP whose TA is valid.

12. The terminal device according to claim 10, wherein if the first timer is associated with one or more TAGs, the target operation is performed for one or more of following objects:
all serving cells of the terminal device;
a TRP associated with each of the one or more TAGs;
a serving cell in which the TRP associated with each of the one or more TAGs is located; or
a serving cell associated with at least one TAG.

13. The terminal device according to claim 10, wherein the first timer is associated with one or more TAGs; or the first timer is associated with one or more TRPs.

14. The terminal device according to claim 2, wherein a TAG in the first information comprises a primary timing advance group PTAG and/or a secondary timing advance group STAG.

15. The terminal device according to claim 1, wherein the first information is carried in a media access control protocol data unit MAC PDU or downlink control information DCI.

16. A network device, comprising a memory and a processor, wherein the memory is configured to store a program, and the processor is configured to invoke the program in the memory to send and receive information through the transceiver, to cause the network device to execute the method comprising:
sending first information, wherein the first information is used to indicate timing advances TAs of one or more transmitting and receiving points TRPs.

17. The network device according to claim 16, wherein the first information comprises a TA of a first timing advance group TAG, and the first TAG is associated with the one or more TRPs.

18. The network device according to claim 17, wherein an association relationship between the first TAG and the one or more TRPs is determined based on configuration information of the network device.

19. The network device according to claim 18, wherein the configuration information of the network device is configuration information of a serving cell of a terminal device, wherein configuration information of each serving cell of the terminal device comprises identities of a plurality of TAGs, and the identities of the plurality of TAGs are separately associated with a plurality of TRPs.

20. A wireless communication method, comprising:
receiving, by a terminal device, first information, wherein the first information is used to indicate timing advances TAs of one or more transmitting and receiving points TRPs.
